(19) United States
(12) Patent Application Publication
(10) Pub. No.: US 2006/0067692 A1
(43) Pub. Date: Mar. 30, 2006

(54) Passive optical network of bus structure

(75) Inventors: Sung-Bum Park, Suwon-si (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/210,079

(22) Filed: Aug. 23, 2005

(30) Foreign Application Priority Data
Sep. 24, 2004 (KR) 2004-77248

(51) Int. Cl. H04J 14/00

(52) U.S. Cl. 398/75

(57) ABSTRACT

Disclosed is a passive optical network of a bus structure. The passive optical network comprises a central office for wavelength-division multiplexing a plurality of time-division multiplexed downstream optical signals with mutually different wavelengths and receiving upstream optical signals, a plurality of remote nodes positioned in series on an optical path linked to the central office, and a plurality of optical network units for detecting a corresponding downstream channel and being linked with a corresponding remote node in order to transmit each upstream channel to the corresponding remote node, wherein each remote node splits a corresponding downstream optical signal into a plurality of downstream channels and transmits upstream channels to the central office by time-division multiplexing the upstream channels to an upstream optical signal.

### CLAIM OF PRIORITY

This application claims priority to that patent application entitled “Passive Optical Network of Bus Structure,” filed in the Korean Intellectual Property Office on Sep. 24, 2004 and assigned Serial No. 2004-77248, the contents of which are incorporated herein by reference.

### BACKGROUND OF THE INVENTION

1. Field of the Invention

The present invention relates to a passive optical network, and more particularly to a passive optical network including a plurality of remote nodes.

2. Description of the Related Art

Generally, a passive optical network ensures superior security by providing a plurality of subscribers with optical signals having their own wavelengths, and easily expands communication capacity by multiplexing predetermined wavelength bands according to necessity.

FIG. 1 illustrates a conventional wavelength-division multiplexed passive optical network (WDM-PON). The WDM-PON includes a central office (CO) 110 for providing communication services, a plurality of optical network units (ONUs) 130-1 to 130-N for receiving the communication services, and a remote node (RN) 120 for relaying the communication services between the CO 110 and the ONUs 130-1 to 130-N.

The CO 110 is linked with the RN 120 through a single optical path in order to transmit downstream optical signals to the RN 120 by multiplexing the downstream optical signals having mutually different wavelengths provided to the ONUs 130-1 to 130-N. Also, the CO 110 can detect upstream optical signals multiplexed in the RN 120 by demultiplexing the upstream optical signals.

The RN 120 demultiplexes the downstream optical signals multiplexed in the CO 110 according to wavelengths and transmits the downstream optical signals to corresponding ONUs 130-1 to 130-N. Also, the RN 120 multiplexes upstream optical signals generated from the ONUs 130-1 to 130-N.

Each of the ONUs 130-1 to 130-N receives a downstream optical signal having a corresponding wavelength demultiplexed in the RN 120 and generates an upstream optical signal in order to transmit the upstream optical signals to the RN 120.

The conventional PON has a double star-type structure in which the CO (110) is linked with the RN (120) through a feeder optical path, and the RN (120) is linked with the subscribers through branched optical paths, so that the conventional PON has been generally used in cities having a plurality of subscribers with the high density of population.

However, in an area having a relatively low density of population, the RN becomes distant from each subscriber, so the conventional PON cannot efficiently provide communication services to each subscriber without requiring a significant amount in installation costs.

Hence, there is a need in the industry for providing optical services to low density population sites without requiring a significant amount in installation costs.

### SUMMARY OF THE INVENTION

Accordingly, the present invention has been made to solve the above-mentioned problems occurring in the prior art, and an object of the present invention is to provide a passive optical network having a bus-type structure, which can safely and economically provide optical communication services in a small city with a lower population density.

In order to accomplish the above object, the present invention provides a passive optical network having a bus-type structure, the passive optical network comprising a central office for wavelength-division multiplexing a plurality of time-division multiplexed downstream optical signals with mutually different wavelengths and receiving upstream optical signals, a plurality of remote nodes positioned in series on an optical path linked to the central office and a plurality of optical network units for detecting a corresponding downstream channel and being linked with a corresponding remote node in order to transmit each upstream channel to the corresponding remote node, wherein each remote node splits a corresponding downstream optical signal into a plurality of downstream channels and transmits upstream channels to the central office by time-division multiplexing the upstream channels to an upstream optical signal.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a conventional wavelength-division multiplexed passive optical network;

FIG. 2 illustrates a passive optical network having a bus-type structure according to a first embodiment of the present invention;

FIG. 3 illustrates a part of a remote node shown in FIG. 2;

FIG. 4 is a graph showing a transmission characteristic of an add/drop multiplexer shown in FIG. 3;

FIG. 5 illustrates a passive optical network having a bus-type structure according to a second embodiment of the present invention;

FIG. 6 illustrates a part of a remote node shown in FIG. 5; and

FIG. 7 is a graph showing a transmission characteristic of an add/drop multiplexer shown in FIG. 6.

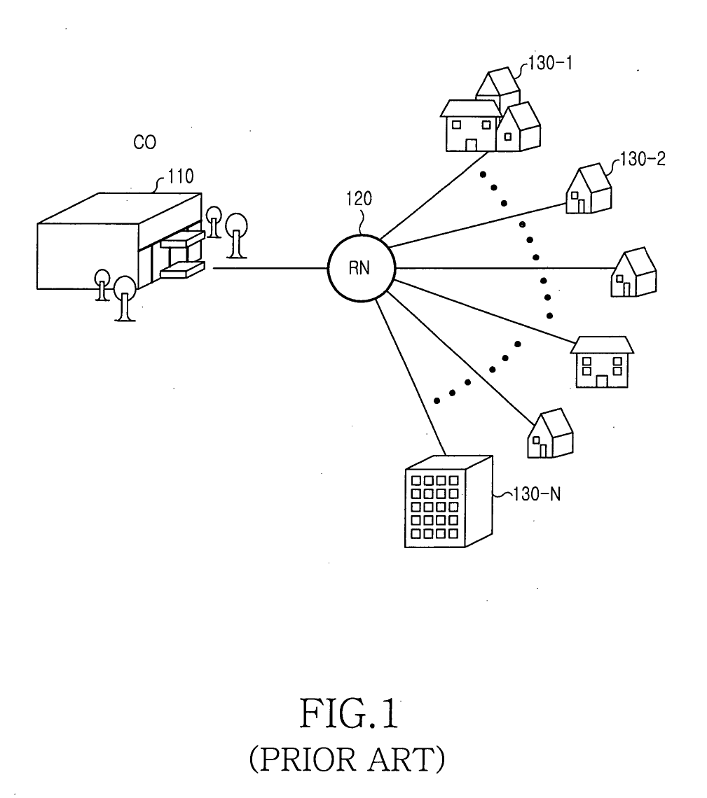

### DETAILED DESCRIPTION

Hereinafter, embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

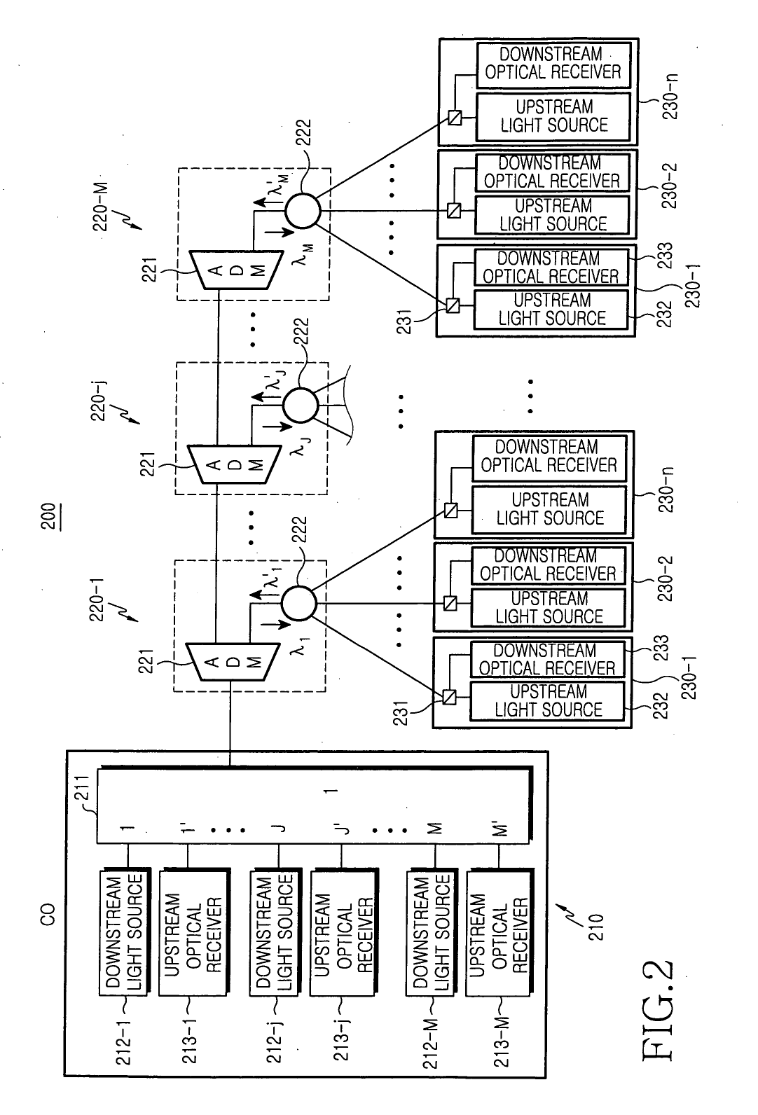

FIG. 2 illustrates a passive optical network 200 having a bus-type structure according to a first embodiment of the present invention. The passive optical network 200 includes a central office (CO) 210 for generating time-division multiplexed and wavelength-division multiplexed downstream optical signals (λ₁ . . . λ_{M}), a plurality remote nodes (RNs) 220-1 to 220-M positioned in series on the optical path linked to the CO 210 for splitting corresponding downstream optical signals, and a plurality of optical network units (ONUs) 230-1 to 230-n which are linked with a corresponding one of RNs 220-1 to 220-M. That is, the CO 210 transmits time-division multiplexed and wavelength-division multiplexed downstream optical signals to each of the RNs 220-1 to 220-M. Each of the RNs 220-1 to 220-M splits a downstream optical signal with a corresponding wavelength into a plurality of downstream channels and transmits the downstream channels to the corresponding ONUs 230-1 to 230-n linked with the corresponding RN.

The CO 210 includes a plurality of downstream light sources 212-1 to 212-M for generating the downstream optical signals, a plurality of upstream optical receivers 213-1 to 213-M for detecting the upstream optical signals having corresponding wavelengths by time-division demultiplexing upstream optical signals into upstream channels, and a multiplexer/demultiplexer 211. Each of the downstream light sources 212-1 to 212-M may include a semiconductor optical amplifier or a semiconductor laser capable of generating an upstream optical signal with a predetermined wavelength. Also, each of the downstream light sources 212-1 to 212-M may include a Fabry-Perot laser for generating a wavelength-locked downstream optical signal.

Each of the upstream optical receivers 213-1 to 213-M may include a burst mode receiver for detecting a corresponding upstream optical signal by time-dividing the corresponding upstream optical signal into a plurality of channels.

The multiplexer/demultiplexer 211 wavelength-division multiplexes the downstream optical signals generated from the downstream light sources and transmits the multiplexed downstream optical signals to the RNs 220-1 to 220-M. The multiplexer/demultiplexer 211 wavelength-division demultiplexes upstream optical signals (λ₁′ . . . λ_{M}′) transmitted from the RNs 220-1 to 220-M and transmits the demultiplexed optical signals to corresponding upstream optical receivers 213-1 to 213-M. The multiplexer/demultiplexer 211 may include an arrayed waveguide grating or a WDM filter.

Each of the RNs 220-1 to 220-M includes an add/drop multiplexer 221 and an optical splitter 222. Each of the RNs 220-1 to 220-M extracts a downstream optical signal with a corresponding wavelength from among the downstream optical signals wavelength-division multiplexed in the CO 210, splits the downstream optical signal into a plurality of downstream channels, and outputs the downstream channels to the corresponding ONUs 230-1 to 230-n. Also, each of the RNs 220-1 to 220-M time-division multiplexes upstream channels, which are generated from the corresponding ONUs 230-1 to 230-n linked therewith, into an upstream optical signal with a predetermined wavelength and outputs the upstream optical signal to the CO 210.

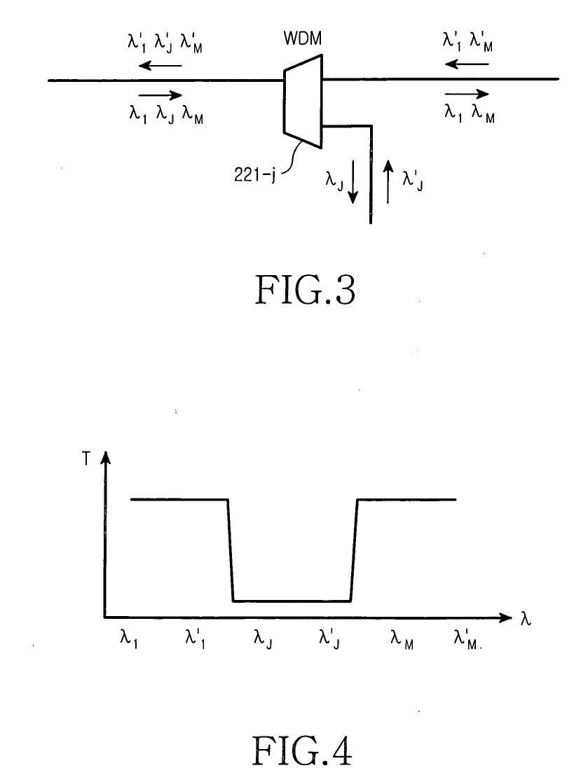

FIG. 3 illustrates a structure of an add/drop multiplexer 221-j included in each of the RNs 220-1 to 220-M shown in FIG. 2. The corresponding add/drop multiplexer 221-j extracts a downstream optical signal with a corresponding wavelength (λⱼ) from among multiplexed downstream optical signals (λ₁ . . . λ_{M}) outputted from the CO 210, and outputs a time-division multiplexed upstream optical signal (λ₁′) to the CO 210. FIG. 4 is a graph showing a transmission characteristic of the add/drop multiplexer 221-j shown in FIG. 3. The add/drop multiplexer 221-j can extract or add a downstream optical signal and an upstream optical signal with mutually different wavelengths by employing an add/drop filter with a wide bandwidth shown in FIG. 4.

Returning to FIG. 2, the optical splitter 222 splits a corresponding downstream optical signal into a plurality of downstream channels and outputs the downstream channels to the corresponding ONUs 230-1 to 230-n linked to the optical splitter 222. Also, the optical splitter/multipler 222 time-division multiplexes upstream channels generated by the corresponding ONUs 230-1 to 230-n to an upstream optical signal and transmits the upstream optical signal to a corresponding add/drop multiplexer 221.

Each of the ONUs 230-1 includes a downstream optical receiver 233 for detecting a corresponding downstream channel branched from the corresponding RN 220-1 linked with the ONUs 230-1, an upstream light source 232 for generating an upstream channel, and a wavelength selective coupler 231 for outputting a corresponding downstream channel transmitted from the corresponding RN 220-1 linked with the ONUs 230-1 to the downstream optical receiver 233 and for outputting the upstream channel generated from the upstream light source 232 to the corresponding RN 220-1.

The upstream optical receivers 213-1 to 213-M and the downstream optical receivers 233 according to the first embodiment of the present invention may include a burst mode optical receiver.

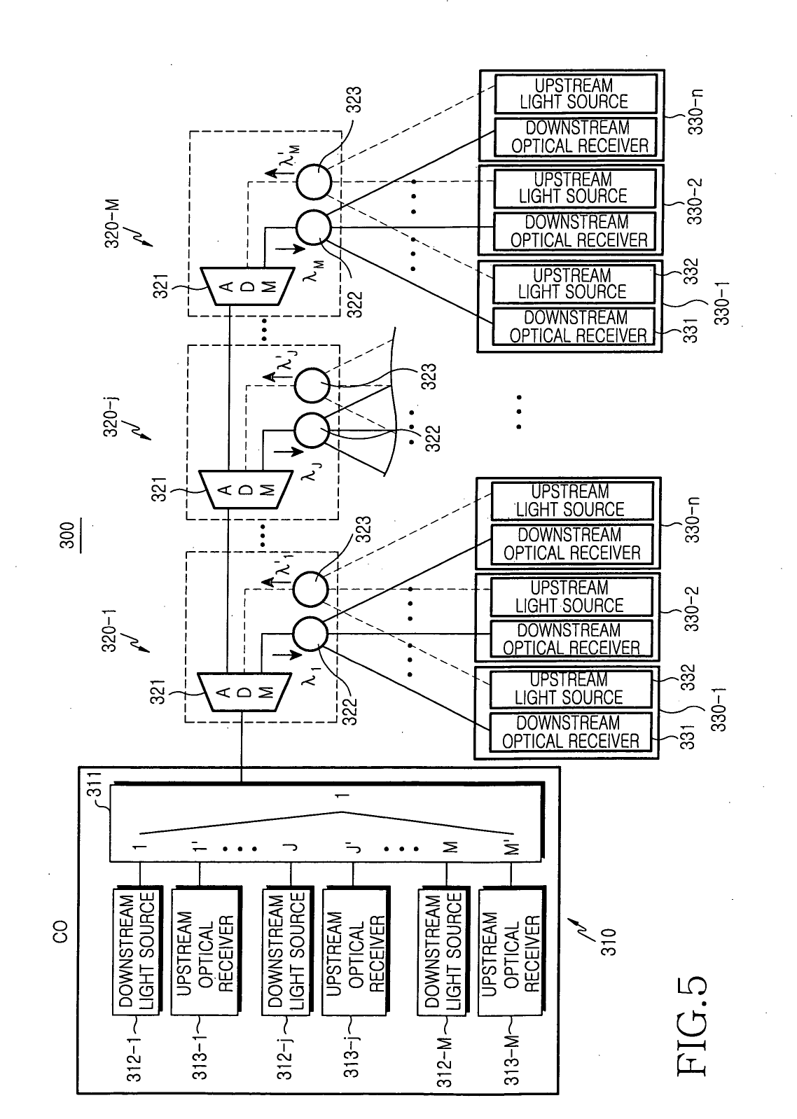

FIG. 5 illustrates a passive optical network 300 having a bus-type structure according to a second embodiment of the present invention. The passive optical network 300 according to the second embodiment of the present invention includes a central office (CO) 310 for generating time-division multiplexed and wavelength-division multiplexed downstream optical signals (λ₁ . . . λ_{M}), a plurality of remote nodes (RNs) 320-1 to 320-M positioned in series on the optical path linked to the CO 310 and for splitting corresponding downstream optical signals, and a plurality of optical network units (ONUs) 330-1 to 330-n linked with a corresponding one of each of the RNs 220-1 to 220-M. In this case, the CO 310 transmits time-division multiplexed and wavelength-division multiplexed downstream optical signals to the RNs 320-1 to 320-M. Each of the RNs 320-1 to 320-M splits a downstream optical signal with a corresponding wavelength into a plurality of downstream channels and transmits the downstream channels to the corresponding ONUs 330-1 to 330-n linked with the RN.

The CO 310 includes a plurality of downstream light sources 312-1 to 312-M for generating time-division multiplexed downstream optical signals, a plurality of upstream optical receivers 313-1 to 313-M for detecting corresponding upstream channels by time-division demultiplexing the corresponding upstream optical signals into the upstream channels, and a multiplexer/demultiplexer 311 for wavelength-division multiplexing the downstream optical signals generated from the downstream light sources 312-1 to 313-M so as to output the downstream optical signals to the RNs 320-1 to 320-M, and for wavelength-division demultiplexing upstream optical signals transmitted from the RNs 320-1 to 320-M so as to the upstream optical signals to the corresponding upstream optical receivers 313-1 to 313-M.

The RNs 320-1 to 320-M are positioned in series on the optical path linked to the CO 310 and include downstream optical splitters 322, upstream optical splitters 323, and add/drop multiplexers 321.

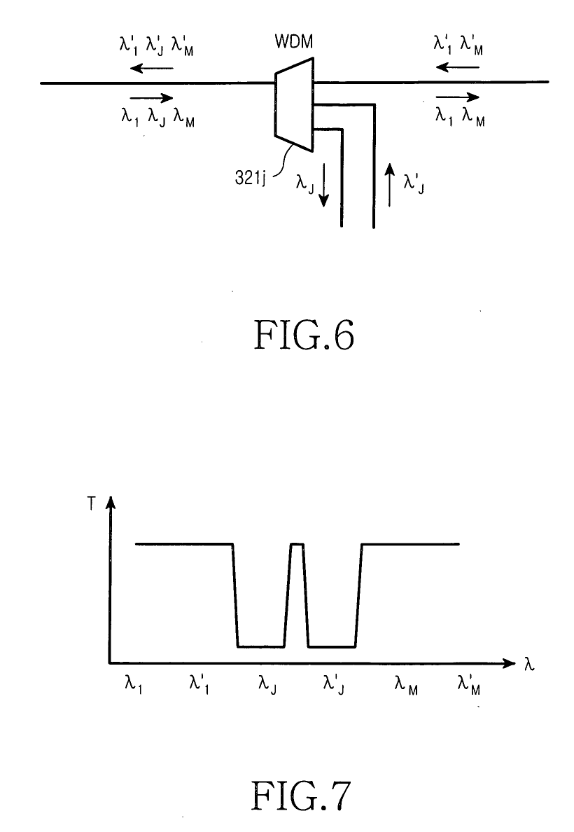

FIG. 6 illustrates only an add/drop multiplexer 321-j included in the j-th remote node 320-j of the remote nodes 320-1 to 320-M shown in FIG. 5. The corresponding add/drop multiplexer 321-j extracts a downstream optical signal with a corresponding wavelength (λⱼ) and outputs a corresponding upstream optical signal (λⱼ′) to the CO 310. As shown in FIG. 6, the add/drop multiplexer 321 according to the second embodiment of the present invention can extract or add a downstream optical signal and an upstream optical signal with mutually different wavelengths by employing an add/drop filter capable of reflecting the wavelengths through two ports of the add/drop multiplexer 321.

Each of the downstream optical splitters 322 splits a downstream optical signal with a corresponding wavelength (λ₁ . . . λ_{M}) into a plurality of downstream channels and transmits the downstream channels to corresponding ONUs 330-1 to 330-n from among a plurality of linked ONUs. Each of the upstream optical splitters 323 time-division multiplexes a plurality of upstream channels to an upstream optical signal (λ₁′ to λ_{M}′) and transmits the upstream optical signal to a corresponding add/drop multiplexer 321.

Each of the ONUs 330-1 to 330-n includes a downstream optical receiver 331 for detecting a corresponding downstream channel from among the downstream channels split in the corresponding downstream optical splitter 322 and an upstream light source 332 for generating an upstream channel and outputting the upstream channel to the upstream optical splitter 323.

The upstream optical receivers 313-1 to 313-M and the downstream optical receiver 331 according to the second embodiment of the present invention may include a burst mode optical receiver.

The PON according to the present invention can efficiently support a greater number of subscribers by employing a time-division multiplexing scheme between each of the remote nodes and subscribers.

In addition, the PON according to the present invention has a bus-type structure in which a plurality of remote nodes are connected to each other through one optical path linked to a central office, so the PON according to the present invention can efficiently and economically provide bi-directional communication services to a middle-sized city or a small-sized city having a lower density of population as compared with that of a large-sized city.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A passive optical network having a bus-type structure, the passive optical network comprising:
a central office for wavelength-division multiplexing a plurality of time-division multiplexed downstream optical signals with mutually different wavelengths and receiving upstream optical signals;
a plurality of remote nodes positioned in series on an optical path linked to the central office; and
a plurality of optical network units for detecting a corresponding downstream channel and being linked with a corresponding remote node in order to transmit each upstream channel to the corresponding remote node, wherein each remote node splits a corresponding downstream optical signal into a plurality of downstream channels and transmits upstream channels to the central office by time-division multiplexing the upstream channels to an upstream optical signal.

2. The passive optical network as claimed in claim 1, wherein the central office includes:
a plurality of downstream light sources for generating the downstream optical signals;
a plurality of upstream optical receivers for detecting a corresponding upstream signal; and
a multiplexer/demultiplexer for multiplexing the downstream optical signals generated from the downstream light sources and transmitting the multiplexed downstream optical signals to the remote nodes by and demultiplexing the upstream optical signal received from the remote nodes and outputting the demultiplexed upstream optical signals transmitted to a corresponding one of the upstream optical receivers.

3. The passive optical network as claimed in claim 2, wherein each of the upstream optical receivers includes a burst mode receiver for detecting each of time-division upstream channels from a corresponding upstream optical signal.

4. The passive optical network as claimed in claim 1, wherein the remote node includes:
an add/drop multiplexer for extracting a downstream optical signal with a corresponding wavelength from among the multiplexed downstream optical signals and outputting the time-division multiplexed upstream optical signal to the central office; and
an optical splitter for outputting the corresponding downstream optical signal to linked optical network units by splitting the corresponding upstream optical signal into a plurality of downstream channels and for outputting the upstream channels transmitted from the optical network units to the add/drop multiplexer by time-division multiplexing the upstream channels to the upstream optical signal.

5. The passive optical network as claimed in claim 1, wherein each of the optical network units includes:
a downstream optical receiver for detecting a corresponding downstream channel;
an upstream light source for generating an upstream channel; and
a wavelength selective coupler for outputting the corresponding downstream channel transmitted from a corresponding linked remote node to the downstream optical receiver and outputting the upstream channel generated from the upstream light source to the corresponding remote node.

6. The passive optical network as claimed in claim 5, wherein the downstream optical receiver includes a burst mode receiver.

7. A passive optical network having a bus-type structure, the passive optical network comprising:
a central office for wavelength-division multiplexing a plurality of time-division multiplexed downstream optical signals with mutually different wavelengths and receiving upstream optical signals;
a plurality of remote nodes positioned in series on the optical path linked to the central office and including:
an add/drop multiplexer for extracting selected ones of the multiplexed downstream optical signal with a corresponding wavelength and outputting the upstream optical signal to the central office;
a downstream optical splitter for splitting the selected downstream optical signal into a plurality of downstream channels, and an upstream optical splitter for outputting a plurality of upstream channels by time-division multiplexing the upstream channels into an upstream optical signal, respectively; and
a plurality of optical network units for detecting a corresponding downstream channel and linked with a corresponding remote node in order to transmit each of upstream channels to the corresponding remote node.

8. The passive optical network as claimed in claim 7, wherein the central office includes:
a plurality of downstream light sources for generating the downstream optical signals;
a plurality of upstream optical receivers for splitting a corresponding upstream optical signal into the upstream channels and detecting each of the upstream channels; and
a multiplexer/demultiplexer for transmitting the downstream optical signals generated from the downstream light sources to the remote nodes by multiplexing the downstream optical signals and for transmitting the upstream optical signals transmitted from the remote nodes to the corresponding upstream optical receiver by demultiplexing the upstream optical signals.

9. The passive optical network as claimed in claim 7, wherein each optical network unit includes:
a downstream optical receiver for detecting a corresponding downstream channel from among the downstream channels split in the downstream optical splitter; and
an upstream light source for generating an upstream channel in order to output the upstream channel to the upstream optical splitter.

10. The passive optical network as claimed in claim 7, wherein the add/drop multiplexer includes:
a filter-type wavelength division multiplexer, for extracting a downstream optical signal with a corresponding wavelength from among the multiplexed downstream optical signals so as to output the downstream optical signal to a corresponding downstream optical splitter, and multiplexing a time-division multiplexed upstream optical signal in a corresponding upstream optical splitter so as to output the multiplexed upstream optical signal to the central office.

11. The passive optical network as claimed in claim 7, wherein the upstream optical receiver includes a burst mode receiver.
